(19) United States
(12) Patent Application Publication
(10) Pub. No.: US 2013/0036230 A1
(43) Pub. Date: Feb. 7, 2013

(54) SOCIAL NETWORK CONNECTIONS

(71) Applicant: Balazs Bakos, Torokbalint (HU)

(72) Inventor: Balazs Bakos, Torokbalint (HU)

(73) Assignee: NOKIA SIEMENS NETWORKS OY, Espoo (FI)

(21) Appl. No.: 13/641,167

(22) PCT Filed: May 5, 2010
(86) PCT No.: PCT/EP2010/056061

§ 371 Date: Oct. 15, 2012

(51) Int. Cl. G06F 15/16

(52) U.S. Cl. 709/227

(57) ABSTRACT

The present invention relates to methods and apparatus for maintaining network connections. One or more new communication events for a first user are identified and a social graph builder receives data relating to the one or more new communication events wherein the data includes data relating to a second user. The social graph builder modifies a social network graph for the first user based on the received data if the identified one or more new communication events fulfills one or more predefined criteria.

The present invention relates to improving social networks connections, in particular to the creation and maintenance of social network connections.

Over the last few years a high number of social networking sites have been created which have become very popular with users. For example, social networking sites MySpace™, Facebook™, and so on have millions of users and subscribers worldwide. Social network sites have redefined the manner in which people interact and communicate with each other as people can now, for example, share experiences and pictures, online chat with friends, leave messages with friends, comment on friends activities, locate old friends and so on. Given the success of the social networking phenomenon there have been many new companies trying to enter the market place with this trend expected to continue in the future.

However, it can often be very difficult for new companies to enter the market place as users of one or more social networking sites find it difficult to move from one service to another. This is because it usually takes significant amount of time and manual effort for a user to locate and connect with their friends at one social networking site and therefore a user is unlikely to move from one social networking site to another. Conventionally, it is difficult to create a user's social network because social connections are typically built up with trust and all social connections have to belong to the same social networking site. For example, user typically must first manually locate and select another user as a friend, e.g. social connection, and then wait for confirmation from their friend. This process has to be completed with all the friends of the user.

Currently, some of the service providers of the social networking sites have developed some recommendation engine or search engine in order to try and make the process of building up a user's social network of connections easier. However, even with the search engines the process is still too long and difficult meaning that a user is unlikely to move to a different social networking site. This long and manual process of building up a social network for each user helps the established incumbent social networking sites to maintain their dominance and achieve a low rate of users leaving the established social networking site for another social networking site irrespective of whether the new social networking site has better functionality and capabilities.

Accordingly, there is presently a need to improve the creation and maintenance of social network connections for a user.

According to a first aspect of the present invention there is provided a method comprising the steps of identifying one or more new communication events for a first user; receiving data relating to the one or more new communication events wherein the data includes data relating to a second user; and modifying a social network graph for the first user based on the received data if the identified one or more new communication events fulfills one or more predefined criteria.

Accordingly, in many of the embodiments a social network graph may be modified based on communication events relating to a first user if those communication events fulfill one or more predefined criteria. The social network graph for a particular user may be used to maintain the connections to other mobile device users. The other mobile device users do not have to have their own social network graph.

A user may have one social network graph or may have several network graphs each directed to a particular group or sub-group of connections. The social network graph may include social contacts and/or professional contacts. The social network graph may be directed to particular sub-groups such as members and supporters of a team.

A communication event for a first user may include the first user initiating communication with a second user or may include the first user receiving communication from a second user. The communication events may include, voice calls, Short Message Service (SMS) messages, Multimedia Message Service (MMS) messages, and so on.

The data that may be received includes data relating to a second user, for example, the second user's mobile device number. Other data received may include the duration of the communication event, the type of communication event and so on.

The social network graph for the first user may be modified if the communication event fulfills one or more predefined criteria. The predefined criteria may be configured by the first user or by the network operator. Each user that has a social network graph may have different set predefined criteria for modifying their social network graph. Depending on the type of social network graph (e.g. friend contacts, professional contacts, and so on) there may be different predefined criteria for each type of social network graph.

For example, one predefined criteria may be if a voice call was made between the first user's mobile communication device and a second user's mobile communication device. Other predefined criteria may be that the voice call was accepted by the second user and a conversation occurred. Further predefined criteria may include an SMS message or MMS message exchange occurred in both directions between the first user's mobile communication device and the second user's mobile communication device. The predefined criteria may also include a threshold that defines a number of interactions between the first user and the second user, for example, the predefined criteria may define that four completed voice calls are made between the first user and the second user. As will be appreciated, any predefined criteria may be defined in relation to modifying a user's social network graph. Moreover, different users may have different predefined criteria for modifying their social network graph depending on the user's requirements.

The step of modifying the social network graph for the first user includes adding the data relating to the second user as a new connection to the social network graph for the first user. Therefore, if the one or more predefined criteria are fulfilled by the communication event then the second user is a connection to the first user that may be added to the first user's social network graph. The connection is made on the social network graph by adding data relating to the second user to the social network graph, for example, the mobile device number of the second user may be added to the first user's social network graph.

If the one or more new communication events fulfill part of the one or more predefined criteria then the method comprises the step of modifying the social network graph for the first user to add the data relating to the second user as a new invite between the first user and the second user. As described hereinabove, if the communication event fulfills the one or more predefined criteria then the social network graph may be modified to include data relating to the new connection between the first user and the second user. However, as also described, the one or more predefined criteria may, for example, define that a voice call (e.g. communication event) has to occur in both directions between the first user and the second user. Therefore, if the communication event relates to the first voice call from the first user to the second user then only part of the one or more predefined criteria is fulfilled. In this case, the social network graph for the first user may be modified to indicate that effectively an invite to join the first user's social network graph has occurred between the first user and the second user. Subsequently, when a communication event occurs where the second user makes a voice call to the first user then this new communication event combined with the invite may fulfill the one or more predefined criteria and the second user may be added to the social network graph for the first user as a connection between the first user and the second user.

The method may further comprise the steps of receiving communication usage history for the first user; processing the communication usage history for the first user to determine the one or more new communication events; and inserting the one or more new communication events as one or more new records into a database. The communication usage history may be collected by a mobile network and the associated network management systems. The communication usage history may be in the form of a Comma Separated Value (CSV) file which may typically include numerous details regarding all users' communication usage. However, as will be appreciated the communication usage history may be stored in any suitable format.

The CSV file may be processed to determine or extract the communication events for each user and insert the communication events as a new record in a database where the database may be configured to enable a fast and efficient access to the new records.

The step of identifying one or more communication events comprises the step of polling the database for new records wherein the new records relate to new communication events for the first user. The database may be periodically polled in order to identify new records which relate to new communication events for the first user. The database may be polled at any suitable time period, for example, every 30 minutes, 60 minutes, 90 minutes, 120 minutes and so on.

The method may further comprise the steps of receiving a request for the social network graph for the first user wherein the request is received from an application; and transmitting at least part of the social network graph for the first user to the application. Accordingly, applications may request the social network graph for the first user and at least part of the social network graph for the user may be transmitted to the application in response to the request.

The complete social network graph may be transmitted to the application or only part of the social network graph, e.g. the new connections, may be transmitted to the application. The applications may be for any purpose where knowing the social network graph of users may be useful to the application, for example, they may relate to social networking sites, professional networking sites, games, location based services, and so on.

According to a second aspect of the present invention there is provided an apparatus comprising: a first processor adapted to identify one or more new communication events for a first user; a first input adapted to receive data relating to the one or more new communication events wherein the data includes data relating to a second user; and a second processor adapted to modify a social network graph for the first user based on the received data if the identified one or more new communication events fulfills one or more predefined criteria.

According to a third aspect of the present invention there is provided an apparatus configure to: identify one or more new communication events for a first user; receive data relating to the one or more new communication events wherein the data includes data relating to a second user; and modify a social network graph for the first user based on the received data if the identified one or more new communication events fulfills one or more predefined criteria.

The second processor may be adapted to modify the social network graph for the first user by being further adapted to add the data relating to the second user as a new connection to the social network graph for the first user.

The apparatus may further comprise a third processor adapted to modify the social network graph for the first user to add the data relating to the second user as a new invite between the first user and the second user if the one or more new communication events fulfill part of the one or more predefined criteria.

The apparatus may further comprise a second input adapted to receive communication usage history for the first user; a fourth processor adapted to process the communication usage history for the first user to determine the one or more new communication events; and a fifth processor adapted to insert the one or more new communication events as one or more new records into a database.

The first processor may be further adapted to poll the database for new records wherein the new records relate to new communication events for the first user.

The apparatus may further comprise a third input adapted to receive a request for the social network graph for the first user wherein the request is received from an application; and an output adapted to transmit at least part of the social network graph for the first user to the application.

The apparatus may be a computing device. The apparatus may be a server. The apparatus may be adapted by hardware, software or any combination thereof.

The first processor, second processor, third processor, fourth processor and fifth processor may be the same processor, different processors or any combination thereof. The first input, second input and third input may be the same input, different inputs or any combination thereof.

According to a fourth aspect of the present invention there is provided a computer program product comprising computer readable executable code for: identifying one or more new communication events for a first user; receiving data relating to the one or more new communication events wherein the data includes data relating to a second user; and modifying a social network graph for the first user based on the received data if the identified one or more new communication events fulfills one or more predefined criteria.

The computer program product may further comprise computer readable executable code for performing any or all of the functions or features in accordance with the aspects and embodiments of the invention.

Embodiments of the present invention will now be described, by way of example only, and with reference to the accompanying drawings, in which:

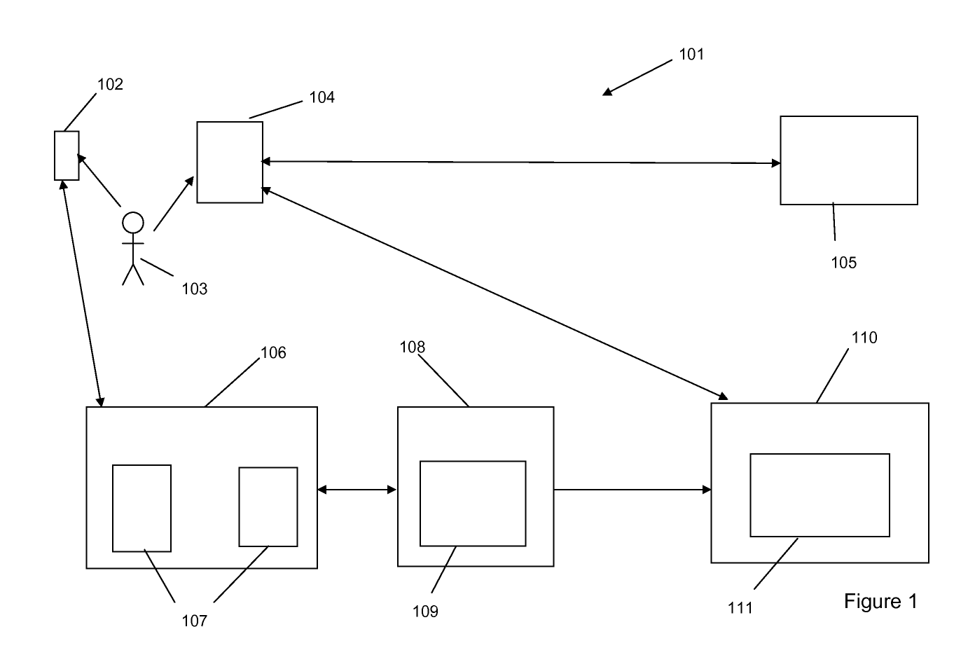

FIG. 1 shows a simplified block diagram of a system in accordance with many embodiments of the present invention.

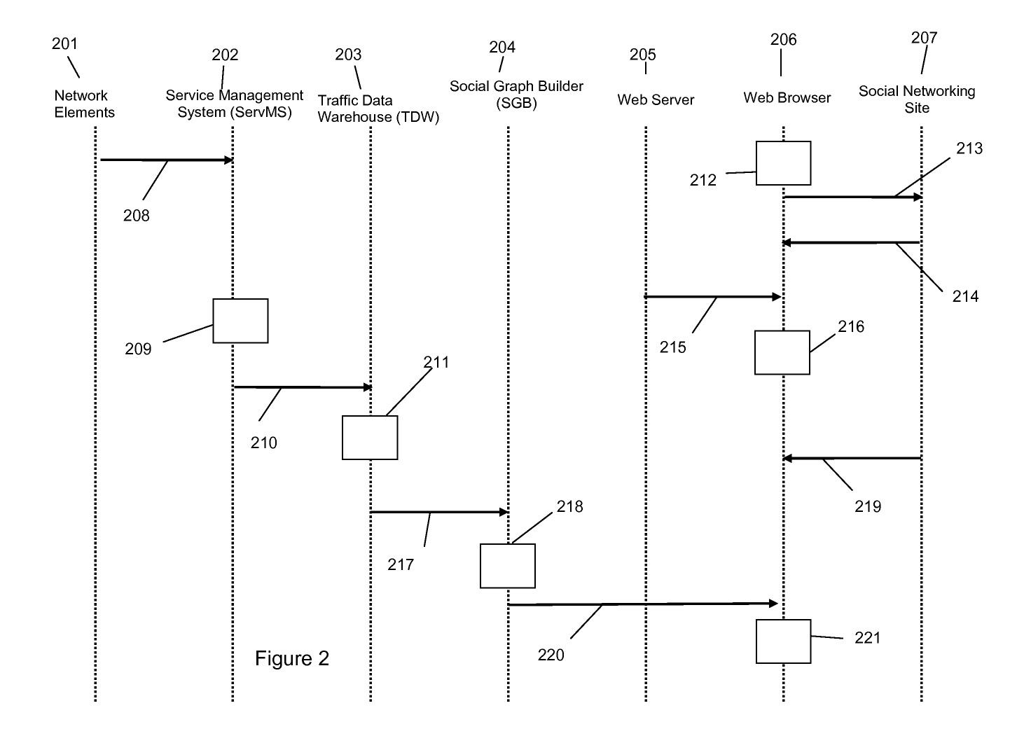

FIG. 2 shows a simplified message flow diagram in accordance with many embodiments of the present invention.

The simplified block diagram of the system 101 in accordance with many embodiments of the present invention may comprise a mobile access network 106 which may include various network elements (NE) 107. The NEs 107 provide various functionality and services in the mobile access network 106 enabling mobile communications to be transmitted, received and controlled. For example, the network elements may include base stations, Mobile Soft-Switching (MSS) server, Mobile Switching Centre (MSC), Serving GPRS Support Node (SGSN) and so on. The mobile access network 106, and the NEs 107, may be operatively connected to a network operator's management systems 108 to enable the network operator to manage and control various aspects of the mobile access network 106. The management systems 108 may include a Network Management System (NMS), an Element Management System (EMS), a Service Management System (ServMS) 109 and so on.

As a person skilled in the art will appreciate, the mobile access network 106 may include any necessary NEs 107 in order to provide the necessary functionality and services. Similarly, the management systems 108 may also include any necessary management systems in order to provide the necessary management and control of the mobile access network 106 and NEs 107.

In many of the embodiments, the management systems 108 may be operatively connected to a Traffic Data Warehouse (TDW) 110.

The TDW 110 may include, or be operatively connected to, a Social Graph Builder (SGB) 111.

The system 101 may include a mobile communication device 102, such as a mobile telephone, which may be operated by a user 103. The system may further include a user device 104, such as a personal computer, mobile device, personal digital assistant and so on. A service provider 105 may also be present in the system 101 where the service provider 105 provides a social networking service.

The user 103, via the user device 104, may wish to access a social networking site provided by the service provider 105. The first time the user 103 accesses the social networking site, via the user device 104, the user 103 will be prompted to register with the service provider 105. During the registration process the user 103, via the user device 104, will provide and/or authenticate themselves with a mobile communication device 102 number. If the mobile communication device 102 number is used to authenticate the user 103 then the service provider 105 may transmit a registration key to the mobile communication device 102, via, for example, a Short Message Service (SMS) message, in order to complete the registration process.

The user 103 uses the mobile communication device 102 to, for example, make voice calls, send Short Message Service (SMS) messages, send Multimedia Message Service (MMS) messages, and so on to third parties. The mobile communication device 102 will connect with the mobile access network 102 and the call, SMS message or MMS message will be transmitted to the relevant recipient.

Each time the mobile communication device 102 transmits or receives data over the mobile access network 106, details of the communication are recorded by one or more of the NEs 107. The recorded details typically relate to a usage history which enables the network operator to correctly bill the user 103 for their usage of the mobile access network 106.

With reference to FIG. 2, which shows a simplified message flow diagram in accordance with many of the embodiments of the present invention, the NEs 201 that recorded details relating to the communication history of the mobile communication device of the user transmits Call Detail Records (CDR) 208 to a ServMS 202 of the management systems. The CDRs may include details of all communication transmitted from the user's mobile communication device and all communication received by the user's mobile communication device. The communication may include, for example, voice calls, SMS messages and MMS messages. The details may include the number of the mobile communication device that the user's mobile communication device is communicating with.

Furthermore, the communication usage history, e.g. the CDRs, may be transmitted to the ServMS 202 in either a push or pull manner. In other words, the CDRs may be automatically transmitted to the ServMS 202 by the NEs 201 (e.g. in a push manner) or the NEs 201 may wait for the ServMS 202 to request the CDRs before transmitting them to the ServMS 202 (e.g. in a pull manner).

The ServMS 202 stores the received CDRs in a database where the database may be integral to the ServMS 202 or operatively attached to the ServMS 202. The ServMS 202 may convert 209 the stored CDR data into a Comma Separated Value (CSV) file and store the CSV file in a predetermined or specified directory on the ServMS 202. The ServMS 202 may convert the usage data, e.g. the CDRs, into a CSV file periodically where the time period between the generation of the CSV files may be predetermined and any time period suitable. For example, the time period may be every 5 minutes, every 10 minutes, every 30 minutes, every hour and so on.

As the communication usage of all mobile communication devices associated with the mobile access network will be expected to be high and therefore the amount of usage data will also be expected to be substantial then in many embodiments a Traffic Data Warehouse (TDW) 203 may be implemented to remove additional load from the ServMS 202 enabling the ServMS 202 to concentrate on its management functions. This may be because the database used by the ServMS 202 is often efficient for handling CDRs and for inserting substantial amounts of data in real time based on the CDRs. However, such a database is typically not efficient for handling queries from other applications, such as for retrieving usage data. Moreover, the ServMS 202 and the associated database may become substantially loaded due to the additional queries which may cause performance problems and affect the primary function of the ServMS 202.

Thus, in many of the embodiments a CSV file of the usage data will be generated by the ServMS 202. The CSV file is a so-called flat file containing usage information from the service usage monitoring systems in the network and the management systems such as the ServMS 202. The CSV file is an efficient format for exporting the substantial amount of usage data that is expected to be generated in the network. The CSV file may contain various pieces of information such as the Mobile Subscriber Integrated Services Digital Network Number (MSISDN) of an initiating party and a terminating party, relevant Cell IDs, duration of a call (if the usage of the mobile devices relates to a voice call), International Mobile Equipment Identity (IMEI) numbers and so on.

The TDW 203 may therefore use a database that may be optimally designed to enable fast access and to support multiple queries from various applications. For example, the database may be a relational database with indexed tables where queries may be executed by Structured Query Language (SQL) commands. By implementing a database that is optimally designed for this purpose then the additional load caused by the data processing and access may be removed from the ServMS 202. However, as a person skilled in the art will appreciate the ServMS 202 may be used to process the CSV file, store the converted data and enable other systems, applications or components access the stored data.

The database used by the TDW 203 may be integrated with the TDW 203 or operatively connected thereto. Accordingly, in many of the embodiments the CSV file from the ServMS 202 directory has to be transferred to the relational database of the TDW 203. This may be achieved by a number of mechanisms.

One example may include transferring the CSV file from the ServMS 202 directory to the TDW 203 database using an Export Transform Load (ETL) job. An ETL job will first export the CSV file to the TDW 203. The ETL job will then transform the CSV file into an appropriate data format for the relational database of the TDW 203 and ensure data consistency, handle exceptions, and so on. Once the CSV file data has been successfully transformed then the ETL job will load the transformed data into the relational database of the TDW 203.

Another example may include transferring the raw CSV file to the TDW 203 which may then process 211 the received CSV file. For example, the TDW 203 may parse the CSV file in order to convert the data into a format that is appropriate to be inserted into the relational database. The TDW 203 may then store the converted data in the relational database of the TDW 203.

The CSV files generated by the ServMS 202 may be transferred 210 to the TDW 203 by any appropriate mechanism periodically, where the time period between each transfer of the CSV files may be predetermined and any suitable time period. For example, the time period may be every 5 minutes, every 10 minutes, every 30 minutes, every hour and so on. Furthermore, the CSV files may be transferred to the TDW 203 by any appropriate mechanism in either a push or pull manner. In other words, the CSV file may be automatically transferred to the TDW 203 by the ServMS 202 (e.g. in a push manner) or the ServMS 202 may wait for the TDW 203 to request the CSV file before transferring it to the TDW 203 (e.g. in a pull manner).

A Social Graph Builder (SGB) 204 component may be used to generate and maintain a social network for a user based on the user's mobile communication usage history. The SGB 204 may be a separate component based on a computing device as a server that is operatively connected to the TDW 203. Alternatively, the SGB 204 may be integrated with the TDW 203.

The SGB 204 periodically polls 217 the TDW 203 database, which stores the data regarding each user's mobile communication history, for new mobile communication usage data relating to each user. As described hereinabove, in many of the embodiments the communication usage data may be stored in the TDW 203 in, for example, a relational database. In the relational database the communication usage data may be arranged, for example, with one table for each different type of communication service (voice call, SMS, MMS etc). For each new user communication event a new record is created in the relevant table. For example, user A with mobile device A initiates a voice call to user B with mobile device B where the voice call is accepted by user B and lasts for 5 minutes. The communication event will be recognised by service usage monitoring systems in the network and the management systems and will be recorded in the CSV file by ServMS 202. As described hereinabove, the CSV file is processed such that a new entry will be created in the voice call table of the relational database in the TDW 203. The SGB 204 may periodically (e.g. every 60 minutes) poll the TDW 203 for new records created in the relational database including the voice call table. The time period at which the SGB 204 polls the relational database in the TDW 203 is predefined at a suitable time period (e.g. 30 minutes, 60 minutes, 90 minutes etc) to maintain the social network graph for each user. The SGB 204 may also include a feature to enable the operator to configure the frequency of the periodic polling.

Alternatively, the database in the TDW 203 may support a notification mechanism. In this case, the SGB 204 may subscribe to the TDW 203 to receive notifications of new records relating to new communication events. Thus, when new communication events for various users are inserted as a new record in the database the TDW 203 may transmit a notification to the SGB 204 of the new record. A predetermined criteria may be defined to regulate the flow of notifications from the TDW 203 to the SGB 204. For example, the notifications may be transmitted at a predetermined schedule, e.g. at a predetermined time(s) of the day, at predetermined time periods, after a predetermined number of new records have been inserted into the database, e.g. after 1000 new records, and so on.

Based on the new communication usage data obtained by the SGB 204, the SGB 204 can create or modify a social network graph for each user 218. The social network graph for each user may be modified based on new communication usage data and predefined criteria. The predefined criteria may define the criteria or rules which must be fulfilled before a user's social network graph is modified.

The user or operator may set or alter the predefined criteria based on the preferences or requirements of the user or network operator. For example, one predefined criteria for a new social connection to be added to a user's social network graph may be if a voice call was made between the user's mobile communication device and another party's mobile communication device. Other predefined criteria may be that the voice call was accepted and a conversation occurred. Further predefined criteria may include an SMS message or MMS message exchange occurred in both directions between the user's mobile communication device and another party's mobile communication device. The predefined criteria may also include a threshold that defines a number of interactions between the user and the other party, for example, the predefined criteria may define that four completed voice calls are made between the user and the other party. As will be appreciated, any predefined criteria may be defined in relation to modifying a user's social network graph. Moreover, different users may have different predefined criteria for modifying their social network graph depending on the user's requirements.

A new social connection may be added to a user's social network graph by adding the mobile communication device number of the other party if the predefined criteria set for the user are fulfilled.

In the example described above, the new communication event of user A having a voice call conversation with user B was recorded in the relational database of the TDW 203. The SGB 204 on polling the relational database of the TDW 203 will identify this new record. In this example, the predefined criteria for modifying the social network graph of user A may include that there has to be a communication event from user A to user B and also a communication event from user B to user A.

Accordingly, in this example, the new communication event record identified by the SGB 204 on polling the TDW 203 indicates that user A initiated and had a voice call conversation with user B. This new communication event is checked against the predefined criteria for modifying user A's social network graph and the SGB 204 identifies that the communication event only fulfills part of the predefined criteria. Accordingly, the SGB 204 cannot yet add user B as a new connection to user A's social network graph. However, the SGB 204 interprets this communication event as a connection invite from user A to user B and records this connection invite in user A's social network graph.

At a later time the SGB 204 on polling the TDW 203 may identify a new communication event where the new communication event relates to user B initiating a voice call with user A which is accepted by user A such that user B and user A have a conversation for several minutes. The SGB 204 identifies that a connection invite from user A to user B exists which fulfilled part of the predefined criteria for modifying user A's social network graph. The new communication event of user B calling user A will fulfill the predefined criteria for modifying user A's social network graph in accordance with this example. It may also be interpreted that user B has accepted user A's connection invite. Thus, the SGB 204 may then modify user A's social network graph to include or add user B as a social connection of user A. The social network graph of user A may be modified by adding the mobile device number of user B as a social connection of user A. If user B is registered with the SGB 204 and if the predefined criteria for user B is the effectively the same as user A then user B's social network graph may also be modified by SGB 204 to include user A as a new social connection of user B.

In this example, the new social connections were made after voice calls between user A and user B. However, as will be appreciated, new social connections may be made after voice calls, SMS messages, MMS messages, etc., or any combination thereof as required by the predefined criteria of each user.

The SGB 204 may also modify the social network graph of a user in order to remove or delete a social connection that is in the user's social network graph. A social connection may be deleted or removed based on predefined criteria, for example, if no communication has occurred between the user and another party for a predetermined period of time. As with the above examples, the predefined criteria may be any criteria that the operator or user defines.

Accordingly, the SGB 204 builds a social network graph for each user registered with or subscribed to the SGB 204 based on the user's mobile usage history. The social network graph generated for each user may then be accessed or used by one or more applications where the applications may be provided by a third party, the network operator or the user. The applications may be for any purpose, for example, social networking, professional networking, gaming, location based services, and so on. The spectrum of possible applications that may access and use a user's social network graph may be wide-ranging and varied.

The example shown in FIG. 2 relates to a social networking site using the social network graph of user A. Accordingly, this embodiment enables an improved process of adding social connections to a particular social networking site. Therefore, in this example the application that accesses the social network graphs for a user is provided by the social networking site. However, as will be appreciated, to further enhance privacy and security of a user's social network graph and the application may be provided by the network operator or a third party or a trusted third party which can access and interface with both the social network graphs and the social networking site.

User A may use or access a social networking site 207, to which user A is registered with or subscribed to, at any time via a web browser 206 on user A's device. The user logs in 212 to the social networking site, for example, by entering a username and password combination into the web browser 206. In order for user A to be granted access to the social networking site the authentication data, e.g. username and password combination, may be transmitted 213 to the social networking site. If user A is authenticated by the social networking site then the relevant content from the social networking site 207 is transmitted 214 to the web browser 206 on the user A's device.

Once user A has access to the social networking site then the application which may interface with both the SGB 204 and the social networking site is loaded 215 into the web browser 206 on user A's device. The application may be loaded from a web server 205. The web server 205 may be operated by the network operator, a service provider, e.g. the social networking site provider, or a third party. Once the application has loaded into the web browser 206 it will start executing 216.

The application may retrieve 219 data regarding the user A's connections from the social networking site 207. The data may include each connection's name, mobile device number along with any other relevant data relating to the friends and the social networking site being accessed. When a user registers to, or subscribes with, the social networking site the user may provide various pieces of information such as their name, mobile device number and so on.

The application may also fetch or retrieve 220 data relating to user A's social network connections from the SGB 204 where the data may include the social connections mobile device number that form user A's social network graph.

The application may then compare 221 the mobile device numbers in user A's social network graph maintained by the SGB 204 with the mobile device numbers of user A's connections on the social networking site in order to identify any new connections that are present in user A's social network graph which are not present in user A's connections on the social networking site based on the connections mobile device number. The application may also automatically or in accordance with any predefined criteria initiate the process to add those new connections to user A's social networking site. Thus, user A's social networking site connections can be automatically created and maintained based on user A's social network graph maintained by the SGB 204 without user A having to manually search for their connections on the social networking site.

The above description of using the maintained social network graph to maintain connections in a social networking site is one simplified example of the use of the social network graph. There are numerous applications that may be developed which can take advantage of the social network graph generated and maintained for users where those applications may cover many varying fields such as gaming, location based services, social or professional networks, and so on.

In the embodiments, a social network graph can be modified and maintained based on a user's mobile device communication usage history. The social network graph may include one or more of friend connections, professional connections, or any other connections such as the members of a team or club that the user is involved with. Each user may have a single maintained social network graph for all their connections or may have any number of social network graphs for different groups of connections, for example, a user may have a social network graph for their friends, another social network graph for their professional contacts and so on.

Accordingly, in many of the embodiments there is described a mechanism for automatically creating, modifying and maintaining a social network graph for a user based on the user's mobile communication usage history. Applications may then access each user's social network graph to provide the user with enhanced and improved features. Thus, each user does not need to manually search for their connections in a service that the user accesses as the social network graph maintained may be used to automatically search and locate the user's connections.

While preferred embodiments of the invention have been shown and described, it will be understood that such embodiments are described by way of example only. Numerous variations, changes and substitutions will occur to those skilled in the art without departing from the scope of the present invention as defined by the appended claims. Accordingly, it is intended that the following claims cover all such variations or equivalents as fall within the spirit and the scope of the invention.

1. A method comprising the steps of:
identifying one or more new communication events for a first user;
receiving data relating to said one or more new communication events wherein said data includes data relating to a second user; and
modifying a social network graph for said first user based on said received data if said identified one or more new communication events fulfills one or more predefined criteria.

2. The method as claimed in claim 1 in which said step of modifying said social network graph for said first user includes adding said data relating to said second user as a new connection to said social network graph for said first user.

3. The method as claimed in claim 1 which if said one or more new communication events fulfill part of said one or more predefined criteria then said method comprises the step of:
modifying said social network graph for said first user to add said data relating to said second user as a new invite between said first user and said second user.

4. The method as claimed in claim 1 further comprising the steps of:
receiving communication usage history for said first user;
processing said communication usage history for said first user to determine said one or more new communication events; and
inserting said one or more new communication events as one or more new records into a database.

5. The method as claimed in claim 4 in which said step of identifying one or more communication events comprises the step of:
polling said database for new records wherein said new records relate to new communication events for said first user.

6. The method as claimed in claim 1, further comprising the steps of:
receiving a request for said social network graph for said first user wherein said request is received from an application; and
transmitting at least part of said social network graph for said first user to said application.

7. An apparatus comprising:
a first processor adapted to identify one or more new communication events for a first user;
a first input adapted to receive data relating to said one or more new communication events wherein said data includes data relating to a second user; and
a second processor adapted to modify a social network graph for said first user based on said received data if said identified one or more new communication events fulfills one or more predefined criteria.

8. The apparatus as claimed in claim 7 in which said second processor is adapted to modify said social network graph for said first user by being further adapted to add said data relating to said second user as a new connection to said social network graph for said first user.

9. The apparatus as claimed in claim 7 further comprising a third processor adapted to modify said social network graph for said first user to add said data relating to said second user as a new invite between said first user and said second user if said one or more new communication events fulfill part of said one or more predefined criteria.

10. The apparatus as claimed in claim 7, further comprising:
a second input adapted to receive communication usage history for said first user;
a fourth processor adapted to process said communication usage history for said first user to determine said one or more new communication events; and
a fifth processor adapted to insert said one or more new communication events as one or more new records into a database.

11. The apparatus as claimed in claim 10 in which said first processor is further adapted to poll said database for new records wherein said new records relate to new communication events for said first user.

12. The apparatus as claimed in claim 7, further comprising:
a third input adapted to receive a request for said social network graph for said first user wherein said request is received from an application; and
an output adapted to transmit at least part of said social network graph for said first user to said application.

13. A computer program product comprising computer readable executable code for:
identifying one or more new communication events for a first user;
receiving data relating to said one or more new communication events wherein said data includes data relating to a second user; and
modifying a social network graph for said first user based on said received data if said identified one or more new communication events fulfills one or more predefined criteria.
